(19) United States
(12) Patent Application Publication
(10) Pub. No.: US 2019/0005610 A1
(43) Pub. Date: Jan. 3, 2019

(54) MOTION-ADAPTING DISPLAYS WITHIN VEHICLES

(71) Applicant: THE BOEING COMPANY, Chicago, IL (US)

(72) Inventor: Brian Tillotson, Seattle, WA (US)

(73) Assignee: THE BOEING COMPANY, Chicago, IL (US)

(21) Appl. No.: 15/635,292

(22) Filed: Jun. 28, 2017

(51) Int. Cl. G06T 3/20; G06K 9/00; B64D 11/00; B64D 43/00

(52) U.S. Cl. CPC G06T 3/20; G06K 9/00832; G06F 3/0488; B64D 43/00; B64D 11/00151

(57) ABSTRACT

A display adaptation system for a vehicle includes a display that is configured to show one or more features. A motion sensor is configured to detect motion of the vehicle. The motion sensor outputs a motion signal indicative of the motion of the vehicle. A motion-compensating control unit is in communication with the display and the motion sensor. The motion-compensating control unit is configured to analyze the motion signal to determine the motion of the vehicle. The motion-compensating control unit is configured to move the feature(s) shown on the display based on the motion of the vehicle.

### FIELD OF THE DISCLOSURE

Embodiments of the present disclosure generally relate to displays within vehicles, and, more particularly, to motion-adapting displays within vehicles.

### BACKGROUND OF THE DISCLOSURE

Various vehicles include interior cabins having touchscreens that are configured to be used by individuals. For example, passengers onboard an aircraft may interact with touchscreens mounted to seats that allow the passengers to select entertainment options, request service from flight attendants, and/or the like. As another example, pilots within a cockpit of the aircraft may interact with one or more touchscreens that are used to control various operational aspects of the aircraft.

During a flight, an aircraft may experience turbulence. The turbulence may cause the fuselage and therefore the interior cabin of the aircraft to move. An individual attempting to engage an operating member of the touchscreen (such as a virtual button) may find it difficult to engage the operating member during periods of turbulence. For example, as the aircraft experiences turbulence, a hand of an individual may move (for example, bounce) in response thereto, and may not contact a desired area of the touchscreen.

Various individuals may find operating a touchscreen onboard a vehicle difficult during periods of unexpected motion (for example, turbulence experienced by an aircraft, an automobile moving over bumps in a road, and the like). A typical touchscreen includes a smooth display surface that is devoid of protruding touch points, such as physical buttons, dials, and knobs. An individual is often unable to physically anchor a hand in relation to the touchscreen during periods of unexpected motion. Consequently, the individual may find it difficult to engage an operating member (such as a virtual button, virtual slider, virtual dial, and/or the like) as the vehicle is in motion.

In an effort to allow for easier operation of a touchscreen, the operating members may be enlarged. A large operating member (such as a virtual button) is easier to engage, because an individual need not be as precise when connecting a finger to the enlarged operating member. However, a larger operating member necessarily occupies an increased amount of space on the touchscreen, which may otherwise be used for other features.

Another option is to use an interface having physical knobs, buttons, levers, and the like, instead of virtual buttons on touchscreens. The physical structures provide anchor points for individuals, and may be easier to engage than virtual buttons during periods of unexpected motion. However, the physical structures add size and weight to an interface. Moreover, such physical structures are typically removed and replaced if upgrades are desired.

### SUMMARY OF THE DISCLOSURE

A need exists for a touchscreen that is easier to use during periods of vehicle motion. Further, a need exists for a touchscreen that allows an individual to accurately engage desired areas during periods of vehicle motion. Additionally, a need exists for a touchscreen that is relatively light and compact.

With those needs in mind, certain embodiments of the present disclosure provide a display adaptation system for a vehicle that includes a display that is configured to show one or more features. A motion sensor is configured to detect motion of the vehicle. The motion sensor outputs a motion signal indicative of the motion of the vehicle. A motion-compensating control unit is in communication with the display and the motion sensor. The motion-compensating control unit is configured to analyze the motion signal to determine the motion of the vehicle. The motion-compensating control unit is configured to move the feature(s) shown on the display based on the motion of the vehicle.

A touchscreen may include the display. The feature(s) may include one or more operating members of the touchscreen.

The motion sensor may include an accelerometer. Optionally, the motion sensor may include a gyro. In at least one embodiment, the motion sensor includes one or more accelerometers and/or one or more gyros. The motion sensor may be secured within an interior cabin of the vehicle.

In at least one embodiment, an impulse response determination control unit is in communication with the motion-compensating control unit. The impulse response determination control unit is configured to associate a plurality of impulse responses of one or more individuals with one or more motions of the vehicle. The motion-compensating control unit is configured to move the feature(s) shown on the display in relation to one or more of the plurality of impulse responses associated with the detected motion of the vehicle.

The impulse response determination control unit may be configured to determine the plurality of impulse responses based on individual test trials. Optionally, the impulse response determination control unit may be configured to determine the plurality of impulse responses based on a kinematic model representative of a human being. Also, optionally, the impulse response determination control unit may be configured to determine the plurality of impulse responses in real time based on one or more actual responses of an individual within the vehicle.

The impulse response determination control unit may be configured to determine the plurality of impulse responses for various motions as a function of one or more parameters including a distance from a shoulder to the display, an elevation angle from the shoulder to the display, an angle of recline for a backrest of a seat, an azimuth angle of the display relative to the shoulder, and/or an acceleration vector the vehicle.

In at least one embodiment, a position-monitoring sub-system is in communication with the impulse response determination control unit. The position-monitoring sub-system is configured to detect a position of an individual relative to the display. The impulse response determination control unit is configured to determine one or more impulse responses of the individual based on the position of the individual relative to the display. The position-monitoring sub-system may include an optical sensor that is configured to detect a position of an individual within an individual position area, a seat sensor that is configured to detect positions of a seat in which the individual is seated, and/or a display sensor that is configured to detect positions of a display relative to the seat.

Certain embodiments of the present disclosure provide a display adaptation method for a vehicle. The display adaptation method includes showing one or more features on a display within the vehicle, detecting motion of the vehicle with a motion sensor, outputting from the motion sensor a motion signal indicative of the motion of the vehicle, communicatively coupling a motion-compensating control unit with the display and the motion sensor, analyzing (by the motion-compensating control unit) the motion signal to determine the motion of the vehicle, and moving (by the motion-compensating control unit) the feature(s) shown on the display based on the motion of the vehicle.

Certain embodiments of the present disclosure provide a vehicle that includes an interior cabin, a seat within the interior cabin, and a display adaptation system including a display associated with the seat. The display is configured to show one or more features.

### BRIEF DESCRIPTION OF THE DRAWINGS

FIG. 1 illustrates a schematic block diagram of a display adaptation system within an interior cabin of a vehicle, according to an exemplary embodiment of the present disclosure.

FIG. 2 illustrates a front view of a display, according to an exemplary embodiment of the present disclosure.

FIG. 3 illustrates a flow chart of a method of adapting a display based on detected motion of a vehicle, according to an exemplary embodiment of the present disclosure.

FIG. 4 illustrates a lateral view of an individual seated within an individual position area of a seat in relation to a display, according to an exemplary embodiment of the present disclosure.

FIG. 5 illustrates a top view of an individual seated within an individual position area of a seat in relation to a display, according to an exemplary embodiment of the present disclosure.

FIG. 6 illustrates a front perspective view of a vehicle, according to an exemplary embodiment of the present disclosure.

FIG. 7 illustrates a top plan view of an interior cabin of an aircraft, according to an exemplary embodiment of the present disclosure.

FIG. 8 illustrates a side view of a seat having an individual position area, according to an exemplary embodiment of the present disclosure.

### DETAILED DESCRIPTION OF THE DISCLOSURE

The foregoing summary, as well as the following detailed description of certain embodiments will be better understood when read in conjunction with the appended drawings. As used herein, an element or step recited in the singular and preceded by the word “a” or “an” should be understood as not necessarily excluding the plural of the elements or steps. Further, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular condition may include additional elements not having that condition.

Certain embodiments of the present disclosure provide a display adaptation system for a vehicle. The display adaptation system includes at least one motion sensor (such as an accelerometer, a gyro, an optical sensor, and/or the like) that is configured to detect motion of a vehicle. The display adaptation system is configured to estimate responsive motion (for example, impulse response) of an individual, and adaptively move at least one feature (such as one or more operating members) on a display of the touchscreen based on the detected motion of the vehicle and the responsive motion of the individual.

In at least one embodiment, the system includes one or more motion sensors, such as accelerometers having known orientations relative to a touchscreen. The touchscreen may have a known location and orientation relative to an individual who operates the touchscreen. The motion sensor(s) detect motion (for example, acceleration, speed, sudden jerks, and the like) of the vehicle in at least one axis. A motion-compensating control unit (which may include one or more processors) analyzes motion signals output by the motion sensor(s) to estimate motion of the touchscreen relative to an individual. In at least one embodiment, the motion-compensating control unit and/or an impulse response determination control unit treats a human arm as a system including a flexible beam and a control system with known parameters. For example, given a particular time sequence of accelerations, the motion-compensating control unit treats each acceleration in a sequence as an impulse and estimates at each point in time a likely offset of a fingertip that an individual attempts to hold over an operating member on the touchscreen. The motion-compensating control unit continually updates the touchscreen to offset each displayed feature from its nominal position based on an estimated fingertip offset.

In some embodiments, the motion-compensating control unit operates in relation to a typical person when a touchscreen location is approximately known. In other embodiments, the motion-compensating control unit operates in relation to a typical person given a specific location of the touchscreen relative to a seat in which the person is seated. In other embodiments, the motion-compensating control unit operates based on parameters in relation to a particular individual operator. In other embodiments, the motion-compensating control unit operates based on parameters in relation to a particular person in a seat in a particular user-specified location relative to the touchscreen. In at least one embodiment, sensors measure the location of an adjustable seat and continually update the parameters used by the processor to compensate for the position of the seat. In at least one embodiment, sensors measure a location of an adjustable display and continually update parameters used to compensate for the position of the display.

In at least one embodiment, the screen is only a display, not a touchscreen. As such, the motion-compensating control unit may move features on the display based on an estimated sight line of an individual, thereby improving an individual's ability to clearly see features on the display, despite turbulent or bumpy motion.

Embodiments of the present disclosure allow operating members of a touchscreen to be (or remain) relatively small, thereby providing increased space on the touchscreen for additional features. Further, more console area can be devoted to a touchscreen and less to physical devices, thereby reducing overall weight, increasing reliability, and improving versatility of an operational interface.

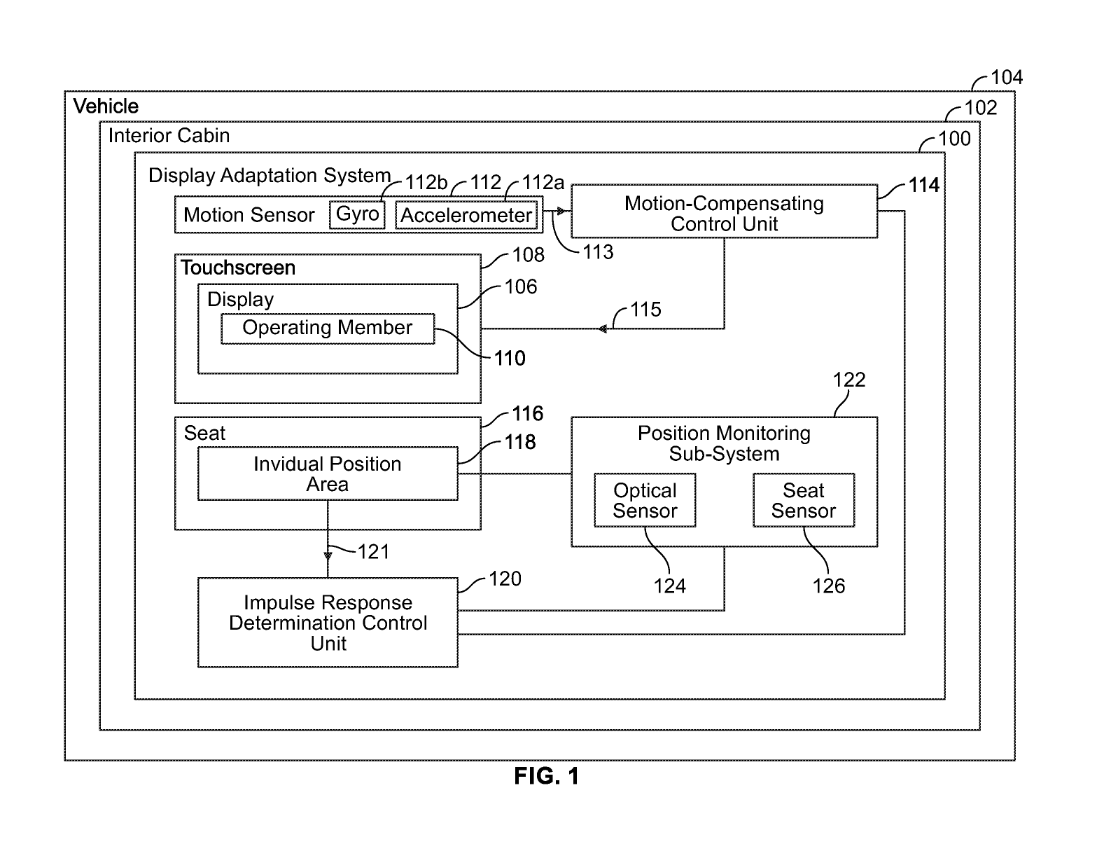

FIG. 1 illustrates a schematic block diagram of a display adaptation system 100 within an interior cabin 102 of a vehicle 104, according to an exemplary embodiment of the present disclosure. The display adaptation system 100 includes a display 106, such as a screen, monitor, or the like that is configured to display visual images, such as graphics, video, and/or the like. In at least one embodiment, the display 106 is part of a touchscreen 108 that allows an individual to select various options and interact via one or more operating members 110, such as virtual buttons, virtual sliders, virtual dials, virtual keys, and/or the like. The operating members 110 provide features on the display 106. In at least one other embodiment, the display 106 is not part of a touchscreen, and the features may include graphics, text, video, and/or the like shown on the display 106.

The display adaptation system 100 also includes one or more motion sensors 112, such as accelerometers 112a, gyros 112b, optical sensors (for example video or still motion cameras, ultrasonic sensors, and/or the like) that are configured to detect motion of the vehicle 104 and output motion signals 113 indicative of the detected motion. In at least one embodiment, the motion sensors 112 include a three-axis accelerometer and at least two gyros, such as mechanical or laser gyros. The motion sensors 112 may be within the interior cabin 102. For example, the motion sensors 112 may be directly coupled to the display 106. In other embodiments, the motion sensors 112 are directly coupled to other structures within the interior cabin 102. In at least one other embodiment, the motion sensors 112 may be secured to the vehicle 104 outside of the interior cabin 102.

A motion-compensating control unit 114 is in communication with the display 106 and the motion sensor 112 through one or more wired or wireless connections. The motion-compensating control unit 114 is configured to monitor the motion signals 113 indicative of the motion of the vehicle 104 that are output by the motion sensor 112. The motion-compensating control unit 114 analyzes the motion signals and adjusts one or more features shown on the display 106 (such as the operating members 110) based on (for example, in response to) the detected motion of the vehicle 104.

The interior cabin 102 also includes one or more seats 116 on which an individual may sit. Each seat 116 includes an individual position area 118, such as defined between an upper surface of a support surface (on which an individual sits), and a backrest. The individual position area 118 is the area of the seat 116 in which an individual is located when seated. An individual that views the display 106 is seated on the respective seat 116. The interior cabin 102 may include a plurality of seats 116 and a respective number of displays 106. Optionally, the interior cabin 102 may include more seats 116 than displays 106.

In at least one embodiment, an impulse response determination control unit 120 is in communication with the seat 116 and the motion-compensating control unit 114, such as through one or more wired or wireless connections. The impulse response determination control unit 120 is configured to estimate physical reactions of an individual seated within the individual position area 118 to motion of the vehicle 104. For example, the impulse response determination control unit 120 may estimate physical responses to motion based on predetermined analyses based on previously-performed experimental or test trials with test individuals, a kinematic model representative of a human being, a typical sized individual within a vehicle, and/or the like.

In at least one embodiment, the impulse response determination control unit 120 may be configured to detect impulse responses 121 of an individual seated within the individual position area in real time during operation of the vehicle 104. That is, the impulse response determination control unit 120 may detect one or more actual responses of an individual within the vehicle 104 during a trip (such as a flight of an aircraft). In this embodiment, the display adaptation system 100 may include a position-monitoring sub-system 122, which may include an optical sensor 124 (such as a still camera, a video camera, ultrasonic sensor, and/or the like) and/or a seat sensor 126 (such as inclinometer, accelerometer, optical encoder, and/or the like). The optical sensor 124 has a field of view that is trained on the individual position area 118, and is configured to detect a position of an individual within the individual position area 118. The seat sensor 126 is in communication with the seat 116, such as through one or more wired or wireless connections, and is configured to detect positions (for example, angle of backrest, height from floor, distance from another structure, and/or the like) of the seat 116. The impulse response determination control unit 120 is in communication the position monitoring sub-system 122 during operation of the vehicle 104, and determines impulse responses of an individual within the individual position area 118 based on optical signals output by the optical sensor 124 and/or seat signals output by the seat sensor 126. Optionally, the display adaptation system 100 may not include the position monitoring sub-system 122.

The impulse response determination control unit 120 and the motion-compensating control unit 114 may be part of an integral control unit, which may include one or more processors, for example. In at least one other embodiment, the impulse response determination control unit 120 and the motion-compensating control unit 114 may be separate and distinct from one another. In at least one embodiment, the impulse response determination control unit 120 may not be within the interior cabin 102. Instead, the impulse response determination control unit 120 may be remotely located from the vehicle 104, and may predetermine impulse responses to various detected movements of the vehicle. The predetermined impulse responses may be stored as impulse data that may be stored within a memory of the display adaptation system 100, such as a memory of the motion-compensating control unit 114.

In operation, the motion sensor 112 detects motion within the interior cabin 102 of the vehicle 104. The motion sensor 112 outputs a corresponding motion signal to the motion compensating-control unit 114. The motion-compensating control unit 114 analyzes an impulse response of an individual seated within the individual position area, as determined empirically, in real time, and/or predetermined by the impulse response determination control unit 120. Based on the motion detected by the motion sensor 112, and a corresponding estimated impulse response of the individual within the individual position area 118 of the seat 116 determined by the impulse response determination control unit 120, the motion-compensating control unit 114 outputs a motion-compensating signal 115 to the display 106 to move one or more features (such as the operating member 110) on the display 106 to compensate for the estimated impulse response of the individual. In this manner, the feature(s) shown on the display 106 adapt to motion of the vehicle 104, thereby allowing the individual to view and/or to accurately engage the feature and eliminate, minimize, or otherwise reduce distorting (for example, bouncing or jerking) effects that would otherwise be caused by motion of the vehicle 104.

As used herein, the term “control unit,” “central processing unit,” “unit,” “CPU,” “computer,” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms. For example, the motion-compensating control unit 114 and the impulse response determination control unit 120 may be or include one or more processors that are configured to control operation of the display adaptation system 100, as described herein.

The motion-compensating control unit 114 and the impulse response determination control unit 120 are configured to execute a set of instructions that are stored in one or more data storage units or elements (such as one or more memories), in order to process data. For example, the motion-compensating control unit 114 and the impulse response determination control unit 120 may include or be coupled to one or more memories. The data storage units may also store data or other information as desired or needed. The data storage units may be in the form of an information source or a physical memory element within a processing machine.

The set of instructions may include various commands that instruct the motion-compensating control unit 114 and the impulse response determination control unit 120 as processing machines to perform specific operations such as the methods and processes of the various embodiments of the subject matter described herein. The set of instructions may be in the form of a software program. The software may be in various forms such as system software or application software. Further, the software may be in the form of a collection of separate programs, a program subset within a larger program or a portion of a program. The software may also include modular programming in the form of object-oriented programming. The processing of input data by the processing machine may be in response to user commands, or in response to results of previous processing, or in response to a request made by another processing machine.

The diagrams of embodiments herein may illustrate one or more control or processing units, such as the motion-compensating control unit 114 and the impulse response determination control unit 120. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like. Optionally, the motion-compensating control unit 114 and the impulse response determination control unit 120 may represent processing circuitry such as one or more of a field programmable gate array (FPGA), application specific integrated circuit (ASIC), microprocessor(s), and/or the like. The circuits in various embodiments may be configured to execute one or more algorithms to perform functions described herein. The one or more algorithms may include aspects of embodiments disclosed herein, whether or not expressly identified in a flowchart or a method.

As used herein, the terms “software” and “firmware” are interchangeable, and include any computer program stored in a data storage unit (for example, one or more memories) for execution by a computer, including RAM memory, ROM memory, EPROM memory, EEPROM memory, and non-volatile RAM (NVRAM) memory. The above data storage unit types are exemplary only, and are thus not limiting as to the types of memory usable for storage of a computer program.

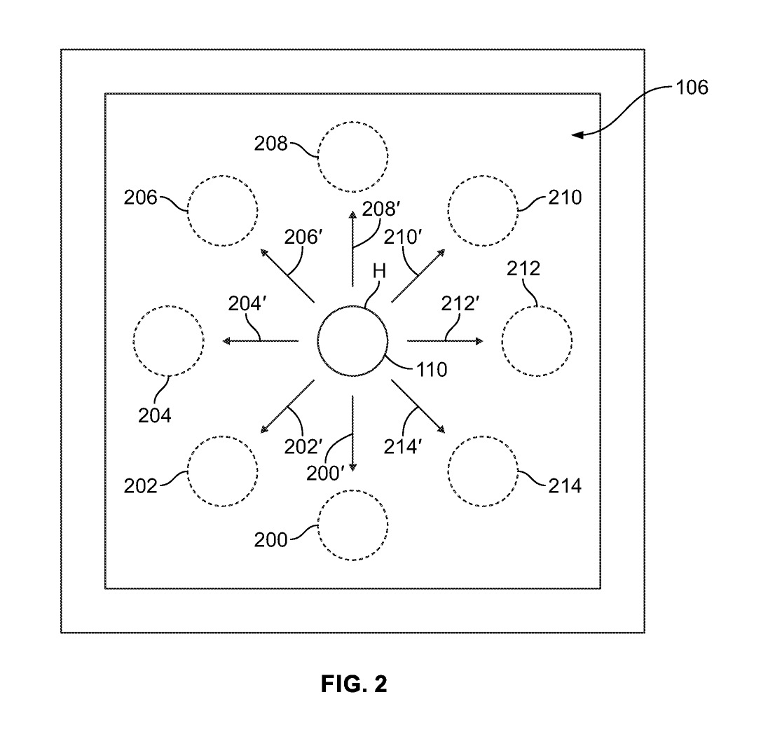

FIG. 2 illustrates a front view of the display 106, according to an exemplary embodiment of the present disclosure. The display 106 may be a monitor, screen, or the like that is configured to electronically show graphic, text, and/or video images. In at least one embodiment, the display 106 is part of the touchscreen 108 (shown in FIG. 1). The display 106 shows at least one feature, such as the operating member 110. In at least one embodiment, the operating member 110 is a virtual button, a virtual slide, a virtual dial, or a virtual key shown on the display 106 of the touchscreen. In other embodiments, the feature is a visual feature (such as a graphic, text, and/or video image) shown on the display 106.

As shown, the operating member 110 has a home position H on the display 106. The home position H is the position of the operating member 110 when detected motion is below a compensating threshold. The compensating threshold is a predetermined minimal amount of detected motion above which the motion-compensating control unit 114 is configured to move the operating member 110 away from the home position H.

Referring to FIGS. 1 and 2, in response to the motion sensor 112 outputting a motion signal that is analyzed by the motion-compensating control unit 114 to exceed the compensating threshold, the motion-compensating control unit 114 determines an impulse response for an individual viewing the operating member 110 and/or attempting to touch the operating member 110 that is associated with the detected motion of the vehicle 104. As noted, the impulse response is determined by the impulse response determination control unit 120 in a predetermined manner (such as via one or more test subjects, kinematic models, and/or the like), and/or in real time via communication with the position-monitoring sub-system 122. Based on detected motion that exceeds the compensating threshold, the motion-compensating control unit 114 adaptively moves the operating member 110 to adjusted positions 200, 202, 204, 206, 208, 210, 212, and 214 on the display 106 based on respective associated compensating movements 200′, 202′, 204′, 206′, 208′, 210′, 212′, and 214′. The positions of the adjusted positions 200-214 and associated compensating movements 200′-214′ are merely exemplary, and are not limiting. It is to be understood that more or less adjusted positions and movements may be used. Further, the magnitude and direction for the movements and positions may be greater or less than shown. Additionally, the operating member 110 may shaped differently, larger, smaller, and/or the like than shown. Moreover, the display 106 may show multiple features, such as multiple operating members 110, that are adaptively moved by the motion-compensating control unit 114 based on detected motion of the vehicle 104.

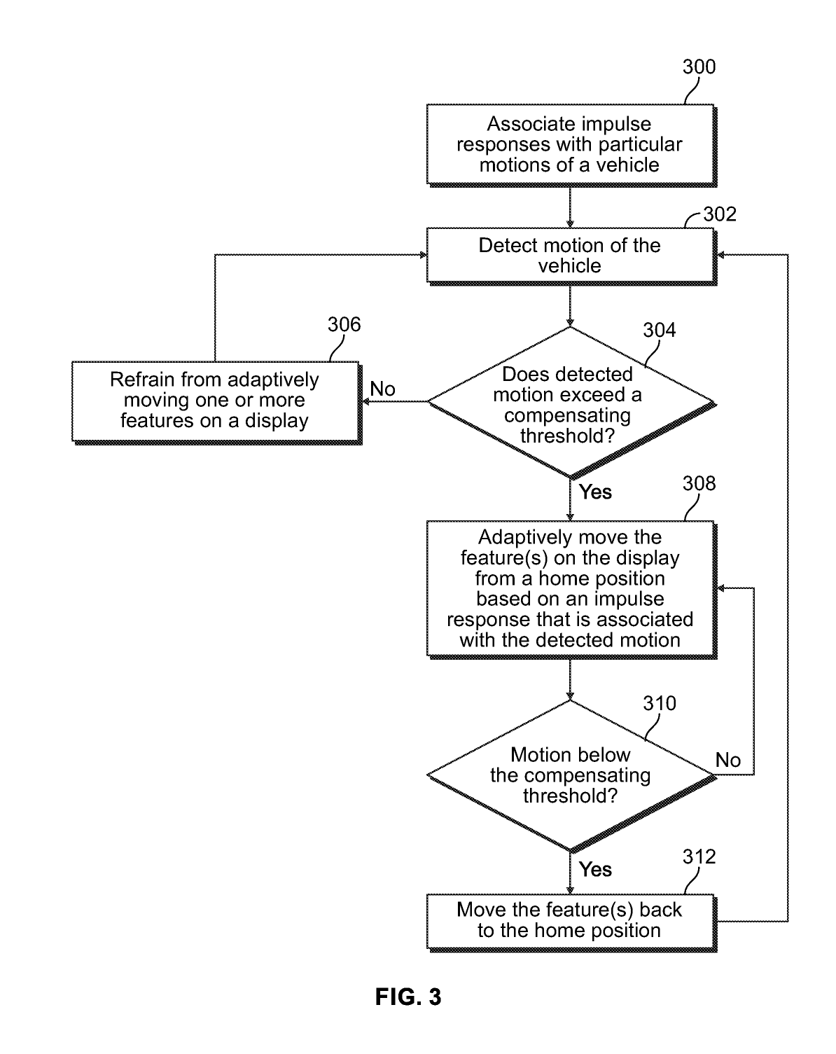

FIG. 3 illustrates a flow chart of a method of adapting a display based on detected motion of a vehicle, according to an exemplary embodiment of the present disclosure. Referring to FIGS. 1 and 3, the method begins at 300, at which the impulse response determination control unit 120 associates impulse responses with particular motions of the vehicle 104. The impulse response determination control unit 120 may determine and associate the impulse responses empirically, through test trials, and/or in real time.

At 302, motion of the vehicle 104 is detected through one or more motion sensors 112, which output motion signals that are analyzed by the motion-compensating control unit 114. At 304, the motion-compensating control unit 114 determines whether the detected motion exceeds a compensating threshold, which is stored in memory (such as a memory of the motion-compensating control unit 114), and which may be zero. If the detected motion does not exceed the compensating threshold, the method proceeds from 304 to 306, at which the motion-compensating control unit 114 refrains from adaptively moving one or more features (such as the operating member(s) 110) on the display 106.

If, however, the detected motion does exceed the compensating threshold at 304, the method proceeds to 308, at which the motion-compensating control unit 114 adaptively moves the feature(s) on the display 106 from a home position to a new position based on an impulse response (as determined by the impulse response determination control unit 120) that is associated with the detected motion. At 310, the motion-compensating control unit 114 determines whether a subsequent detected motion is below the compensating threshold. If the subsequent detected motion is not below the compensating threshold, the method returns to 308.

If, however, the subsequent detected motion is below the compensating threshold at 310, the method proceeds to 312, at which the motion-compensating control unit 114 moves the feature(s) back to the home position(s), such as at a rate corresponding to a decay (for example, stabilization, correction, or other such cessation) of an impulse response for an individual viewing the display 106. The method then returns to 302.

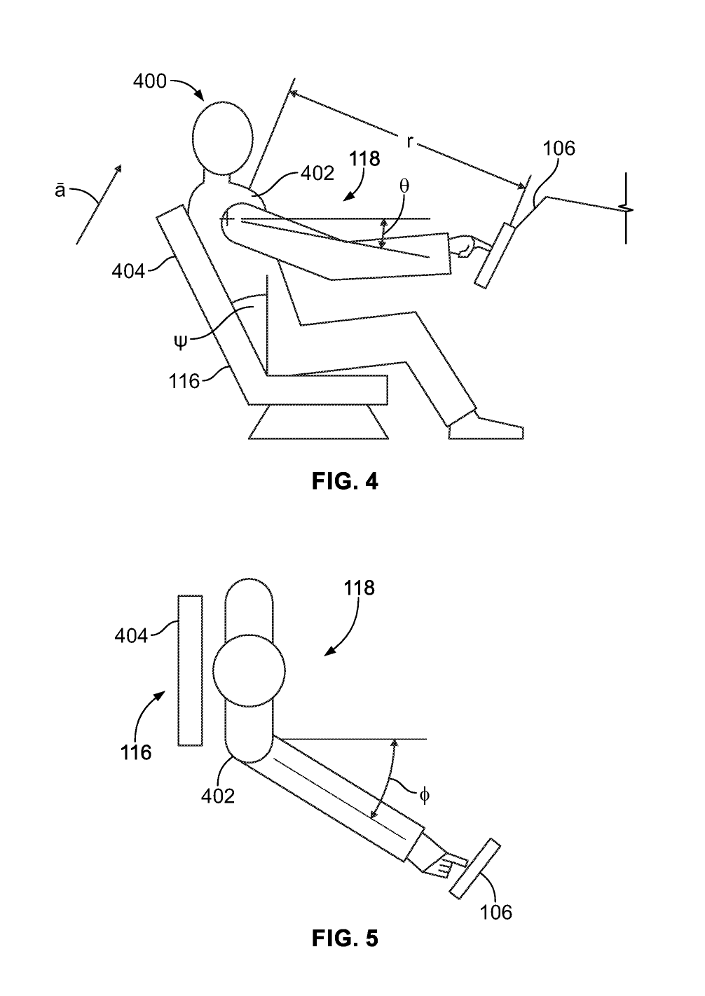

FIG. 4 illustrates a lateral view of an individual 400 seated within an individual position area 118 of a seat 116 in relation to a display 106, according to an exemplary embodiment of the present disclosure. FIG. 5 illustrates a top view of the individual 400 seated within the individual position area 118 of the seat 116 in relation to the display 106. Referring to FIGS. 1, 4, and 5, the impulse response determination control unit 120 is configured to determine various impulse responses of the individual 400 associated with various motions of the vehicle 104. As shown, the individual may be a test subject, such as an averaged sized person of average musculature. In at least one other embodiment, the individual may be a kinematic model of a human. In at least one other embodiment, the individual may be an actual person onboard the vehicle 104, as monitored by the position monitoring sub-system 122.

The impulse response determination control unit 120 may determine various impulse responses for various motions as a function of various parameters. The parameters may include: a distance r from a shoulder 402 to the display 106, an angle θ, which may be an elevation angle from the shoulder 402 to the display, an angle Ψ, which is an angle of recline for a backrest 404 of the seat 116, an angle Φ, which is the azimuth angle of the display relative to the shoulder 402, and/or an acceleration vector a of the vehicle, as detected by the motion sensor 112. The impulse response determination control unit 120 may analyze more or less parameters than those shown and described, in order to determine various impulse responses.

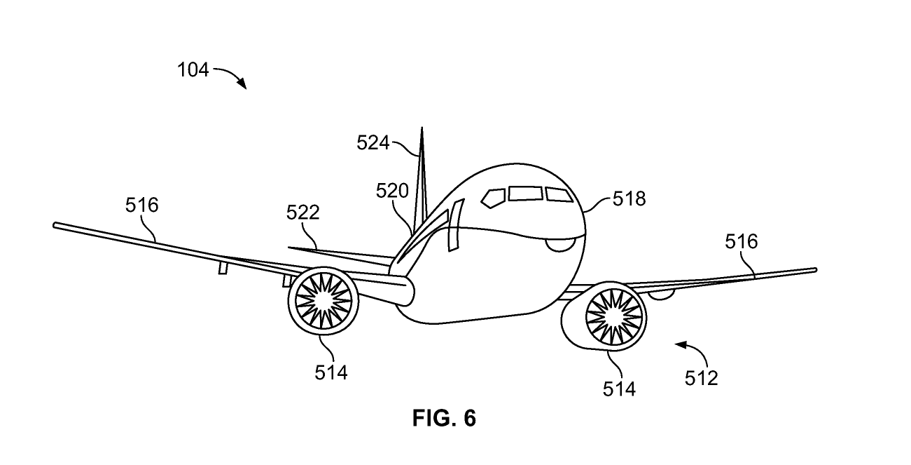

FIG. 6 illustrates a front perspective view of the vehicle 104, such as an aircraft, according to an exemplary embodiment of the present disclosure. The aircraft 104 includes a propulsion system 512 that may include two turbofan engines 514, for example. Optionally, the propulsion system 512 may include more engines 514 than shown. The engines 514 are carried by wings 516 of the aircraft 104. In other embodiments, the engines 514 may be carried by a fuselage 518 and/or an empennage 520. The empennage 520 may also support horizontal stabilizers 522 and a vertical stabilizer 524. The fuselage 518 of the aircraft 104 defines an interior cabin, which includes a cockpit and passenger area.

Alternatively, instead of an aircraft, embodiments of the present disclosure may be used with various other vehicles, such as automobiles, buses, locomotives and train cars, seacraft, spacecraft, and the like.

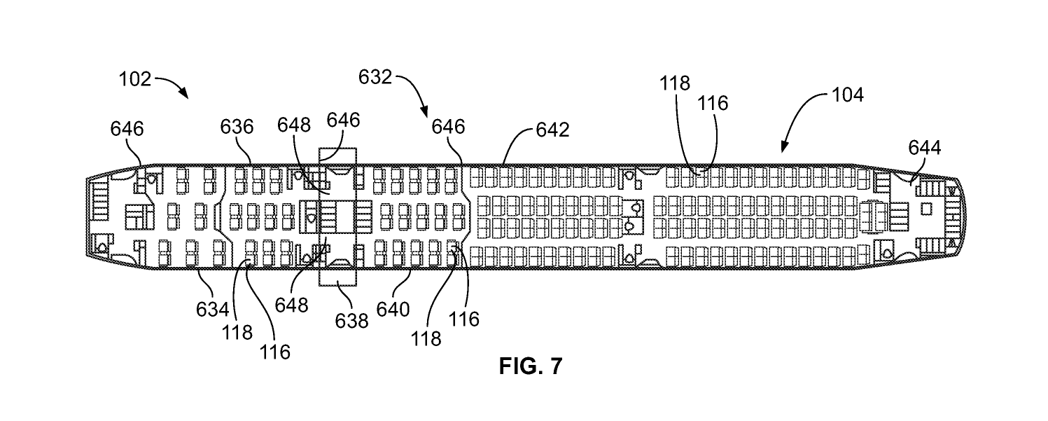

FIG. 7 illustrates a top plan view of an interior cabin 102 of a vehicle 104 (such as an aircraft), according to an exemplary embodiment of the present disclosure. The interior cabin 102 may be within a fuselage 632 of the vehicle 104. The interior cabin 102 may include multiple sections, including a first class section 634, a business class section 636, a front galley section 638, an expanded economy or coach section 640, a standard economy of coach section 642, and a rear galley section 644. It is to be understood that the interior cabin 102 may include more or less sections than shown. For example, the interior cabin 102 may not include a first class section, and may include more or less galley sections than shown. Each of the sections may be separated by a cabin transition area 646, which may include curtain assemblies between structural features (such as monuments, overhead bins, or the like) within aisles 648. The vehicle 104 may include more or less aisles than shown.

The vehicle 104 includes a plurality of seats 116, each including an individual position area 118. The vehicle 104 may include more or less seats 116 than shown.

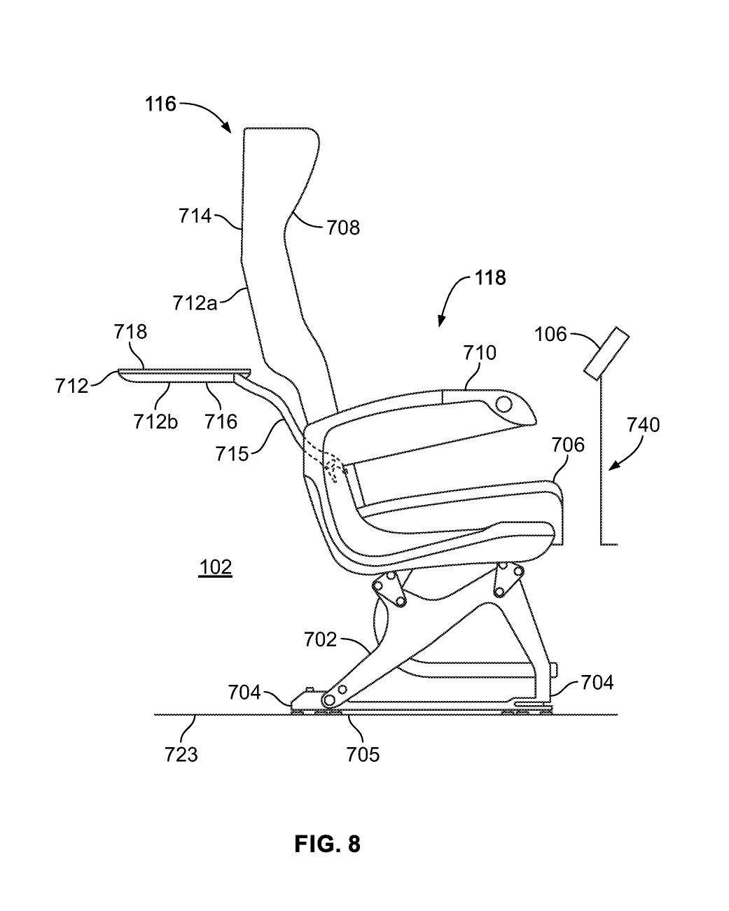

FIG. 8 illustrates a side view of a seat (or seat assembly) 116 having an individual position area 118, according to an exemplary embodiment of the present disclosure. The seat 116 is configured to be secured within a cabin of a vehicle, such as a commercial aircraft.

The seat 116 includes a base 702 having legs 704 that may be secured to tracks 705 within a cabin of a vehicle. The legs 704 may include fittings, fasteners, or the like that are configured to securely connect the legs 704 to the tracks 705. The base 702 supports a seat cushion 706 and a backrest 708 (an example of the backrest 404 shown in FIGS. 4 and 5). Arm rests 710 may be pivotally secured to the backrest 708.

A tray table 712 may be moveably secured to a back 714 of the backrest 708 through lateral arms 715 that are pivotally secured to the back 714. The tray table 712 is configured to be moved between a stowed, upright position 712a and a supporting position 712b. In the upright position 712a, the tray table 712 is securely locked in place such that an underside 716 may be flush with the back 714.

In the supporting position 712b, s supporting surface 718 of the tray table 712 may be exposed and substantially parallel to a floor 723 of the interior cabin 102. As such, a passenger may rest objects, such as cups, cans, or the like, on the supporting surface 718 in the supporting position 712b.

A display 106 is associated with the individual position area 118. The display 106 may be moveably secured to an arm rest 710 of the seat 116. In at least one other embodiment, the display 106 may be fixed or moveably secured to a back of another seat in front of the seat 116. In at least one embodiment, a structure 740 (such as another seat) may change orientation and location. The position monitoring subsystem 122 (shown in FIG. 1) may monitor the structure 740 instead of, or in addition to, a position of the seat 116 on which the individual is seated.

As described herein, embodiments of the present disclosure provide systems and methods that allow for easy and reliable use of displays (such as those of touchscreens), particularly during periods of vehicle motion. Further, embodiments of the present disclosure provide systems and methods that allow individuals to accurately engage desired areas of touchscreens during periods of vehicle motion. Moreover, embodiments of the present disclosure provide touchscreens that may be devoid of physical engagement members, thereby ensuring that the touchscreens remain relatively light and compact.

While various spatial and directional terms, such as top, bottom, lower, mid, lateral, horizontal, vertical, front and the like may be used to describe embodiments of the present disclosure, it is understood that such terms are merely used with respect to the orientations shown in the drawings. The orientations may be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the disclosure without departing from their scope. While the dimensions and types of materials described herein are intended to define the parameters of the various embodiments of the disclosure, the embodiments are by no means limiting and are exemplary embodiments. Many other embodiments will be apparent to those of skill in the art upon reviewing the above description. The scope of the various embodiments of the disclosure should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various embodiments of the disclosure, including the best mode, and also to enable any person skilled in the art to practice the various embodiments of the disclosure, including making and using any devices or systems and performing any incorporated methods. The patentable scope of the various embodiments of the disclosure is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

1. A display adaptation system for a vehicle, the display adaptation system comprising:
a display that is configured to show one or more features;
a motion sensor that is configured to detect motion of the vehicle, wherein the motion sensor outputs a motion signal indicative of the motion of the vehicle; and
a motion-compensating control unit in communication with the display and the motion sensor, wherein the motion-compensating control unit is configured to analyze the motion signal to determine the motion of the vehicle, and wherein the motion-compensating control unit is configured to move the one or more features shown on the display based on the motion of the vehicle.

2. The display adaptation system of claim 1, further comprising a touchscreen, wherein the touchscreen includes the display, and wherein the one or more features include one or more operating members of the touchscreen.

3. The display adaptation system of claim 1, wherein the motion sensor comprises one or more of an accelerometer or a gyro.

4. The display adaptation system of claim 1, wherein the motion sensor is secured within an interior cabin of the vehicle.

5. The display adaptation system of claim 1, further comprising an impulse response determination control unit in communication with the motion-compensating control unit, wherein the impulse response determination control unit is configured to associate a plurality of impulse responses of one or more individuals with one or more motions of the vehicle, and wherein the motion-compensating control unit is configured to move the one or more features shown on the display in relation to one or more of the plurality of impulse responses associated with the detected motion of the vehicle.

6. The display adaptation system of claim 5, wherein the impulse response determination control unit is configured to determine the plurality of impulse responses based on individual test trials.

7. The display adaptation system of claim 5, wherein the impulse response determination control unit is configured to determine the plurality of impulse responses based on a kinematic model representative of a human being.

8. The display adaptation system of claim 5, wherein the impulse response determination control unit is configured to determine the plurality of impulse responses in real time based on one or more actual responses of an individual within the vehicle.

9. The display adaptation system of claim 5, wherein the impulse response determination control unit is configured to determine the plurality of impulse responses for various motions as a function of one or more parameters including a distance from a shoulder to the display, an elevation angle from the shoulder to the display, an angle of recline for a backrest of a seat, an azimuth angle of the display relative to the shoulder, or an acceleration vector the vehicle.

10. The display adaptation system of claim 5, further comprising a position-monitoring sub-system in communication with the impulse response determination control unit, wherein the position-monitoring sub-system is configured to detect a position of an individual relative to the display, and wherein the impulse response determination control unit is configured to determine one or more impulse responses of the individual based on the position of the individual relative to the display.

11. The display adaptation system of claim 10, wherein the position-monitoring sub-system comprises one or more of:
an optical sensor that configured to detect a position of an individual within an individual position area;
a seat sensor that is configured to detect positions of a seat in which the individual is seated; or
a display sensor that is configured to detect positions of the display relative to the seat.

12. A display adaptation method for a vehicle, the display adaptation method comprising:
showing one or more features on a display within the vehicle;
detecting motion of the vehicle with a motion sensor;
outputting from the motion sensor a motion signal indicative of the motion of the vehicle;
communicatively coupling a motion-compensating control unit with the display and the motion sensor;
analyzing, by the motion-compensating control unit, the motion signal to determine the motion of the vehicle; and
moving, by the motion-compensating control unit, the one or more features shown on the display based on the motion of the vehicle.

13. The display adaptation method of claim 12, further comprising securing the motion sensor within an interior cabin of the vehicle.

14. The display adaptation method of claim 12, further comprising:
communicatively coupling an impulse response determination control unit with the motion-compensating control unit;
associating, by the impulse response determination control unit, a plurality of impulse responses of one or more individuals with one or more motions of the vehicle, and
wherein the moving comprises moving the one or more features shown on the display in relation to one or more of the plurality of impulse responses associated with the detected motion of the vehicle.

15. The display adaptation method of claim 14, further comprising using the impulse response determination control unit to determine the plurality of impulse responses based on one or more of individual test trials, a kinematic model representative of a human being, on one or more actual responses of an individual within the vehicle.

16. The display adaptation method of claim 14, further comprising using the impulse response determination control unit to determine the plurality of impulse responses for various motions as a function of one or more parameters including a distance from a shoulder to the display, an elevation angle from the shoulder to the display, an angle of recline for a backrest of a seat, an azimuth angle of the display relative to the shoulder, or an acceleration vector the vehicle.

17. The display adaptation method of claim 14, further comprising:
communicatively coupling a position-monitoring sub-system with the impulse response determination control unit;
using the position-monitoring sub-system to detect a position of an individual within the vehicle; and
using the impulse response determination control unit to determine one or more impulse responses of the individual based on the position of the individual within the vehicle.

18. A vehicle comprising:
an interior cabin;
a seat within the interior cabin; and
a display adaptation system comprising:
a display associated with the seat, wherein the display is configured to show one or more features;
a motion sensor that is configured to detect motion of the vehicle, wherein the motion sensor outputs a motion signal indicative of the motion of the vehicle;
a motion-compensating control unit in communication with the display and the motion sensor, wherein the motion-compensating control unit is configured to analyze the motion signal to determine the motion of the vehicle, and wherein the motion-compensating control unit is configured to move the one or more features shown on the display based on the motion of the vehicle;
an impulse response determination control unit in communication with the motion-compensating control unit, wherein the impulse response determination control unit is configured to associate a plurality of impulse responses of one or more individuals with one or more motions of the vehicle, and wherein the motion-compensating control unit is configured to move the one or more features shown on the display in relation to one or more of the plurality of impulse responses associated with the detected motion of the vehicle; and
a position-monitoring sub-system in communication with the impulse response determination control unit, wherein the position-monitoring sub-system is configured to detect a position of an individual within the vehicle, and wherein the impulse response determination control unit is configured to determine one or more impulse responses of the individual based on the position of the individual within the vehicle.

19. The vehicle of claim 18, further comprising a touchscreen, wherein the touchscreen includes the display, and wherein the one or more features include one or more operating members of the touchscreen.

20. The vehicle of claim 18, wherein the impulse response determination control unit is configured to determine the plurality of impulse responses for various motions as a function of one or more parameters including a distance from a shoulder to the display, an elevation angle from the shoulder to the display, an angle of recline for a backrest of a seat, an azimuth angle of the display relative to the shoulder, or an acceleration vector the vehicle.
